(19) United States
(12) Patent Application Publication
(10) Pub. No.: US 2009/0244452 A1
(43) Pub. Date: Oct. 1, 2009

(54) LIQUID CRYSTAL DISPLAY ELEMENT AND ELECTRONIC PAPER UTILIZING THE SAME

(75) Inventors: Toshiaki Yoshihara, Kawasaki (JP); Makoto Fukuda, Kawasaki (JP); Yoshihisa Kurosaki, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/480,770

(22) Filed: Jun. 9, 2009

Related U.S. Application Data
(63) Continuation of application No. PCT/JP2006/325376, filed on Dec. 20, 2006.

(51) Int. Cl. G02F 1/1347; G02F 1/1333; G02F 1/1337

(52) U.S. Cl. 349/115; 349/160; 349/123

(57) ABSTRACT

The invention relates to a liquid crystal display element for displaying images by driving a liquid crystal material, in particular, a liquid crystal composition exhibiting a cholesteric phase and relates to electronic paper utilizing the element. The invention provides a liquid crystal display element having improved display quality achieved by suppressing image sticking and electronic paper utilizing the element. The liquid crystal display element includes a pair of substrate disposed opposite to each other and a liquid crystal layer enclosed between the pair of substrates. Interfaces of the pair of substrates in contact with the liquid crystal layer are formed to have surface roughness of 1.5 nm or less or, more preferably, 0.8 nm or less.

This application is a continuation of International Application No. PCT/JP2006/325376, filed Dec. 20, 2006.

### BACKGROUND OF THE INVENTION

1. Field of the Invention

The present invention relates to a liquid crystal material and, more particularly, to a liquid crystal display element for displaying images by driving a liquid crystal composition exhibiting a cholesteric phase and electronic paper utilizing the element.

2. Background of the Invention

Recently, various enterprises and universities are actively engaged in the development of electronic paper. The most promising field of application of electronic paper is electronic books, and other promising fields include the field of portable apparatus such as mobile terminal sub-displays and display sections of IC cards. One type of display elements used in electronic paper is liquid crystal display elements utilizing a cholesteric liquid crystal composition which forms a cholesteric phase (such a composition is called a cholesteric liquid crystal or chiral nematic liquid crystal and will hereinafter be referred to as “cholesteric liquid crystal”). A liquid crystal display element utilizing a cholesteric liquid crystal has excellent characteristics such as semi-permanent display retention characteristics (capability of displaying an image when no electric power is supplied; memory characteristics), vivid color display characteristics, high contrast characteristics, and high resolution characteristics.

Patent Document 1: JP-A-2000-292777

A liquid crystal display element displaying an image utilizing a memorized state of the cholesteric liquid crystal has the problem of image sticking. Image sticking is the phenomenon of visible retention of a previously displayed image in a screen, which can occur when a screen rewrite is performed after a fixed image is continuously displayed for a long time in the memorized state. The image sticking phenomenon is a significant problem in display elements characterized by memorized display because it degrades display quality, and the cause of the phenomenon has not been clearly identified yet.

### SUMMARY OF THE INVENTION

It is an object of the invention to provide a liquid crystal display element having high display quality by suppressing image sticking and to provide electronic paper utilizing the element.

The above-described object is achieved by a liquid crystal display element including a pair of substrates disposed opposite to each other, and a liquid crystal layer enclosed between the pair of substrates, wherein an interface of the pair of substrates in contact with the liquid crystal layer has surface roughness of 1.5 nm or less.

The above invention is characterized in that the surface roughness is 0.8 nm or less. The above invention is characterized in that at least either of the pair of substrates includes an electrode formed on the side of the interface, and the surface roughness is the roughness of a surface of the electrode. The above invention is characterized in that at least either of the pair of substrates includes an insulation film formed on the side of the interface and wherein the surface roughness is the roughness of a surface of the insulation film. The above invention is characterized in that at least either of the pair of substrates includes an alignment film formed on the side of the interface and wherein the surface roughness is the roughness of a surface of the alignment film.

The above invention is characterized in that the liquid crystal layer includes a liquid crystal which forms a cholesteric phase. The above invention is characterized in that a plurality of the pairs of substrates having the liquid crystal layer enclosed therein are stacked one over another.

The above invention is characterized in that the pairs of substrates having the liquid crystal layer enclosed therein are stacked as top, middle, and bottom layers and wherein the liquid crystal in the middle layer has optical rotatory power different from that of the top and bottom layers. The above invention is characterized in that the liquid crystal in the top layer selectively reflects blue light in a planar state, the liquid crystal in the middle layer selectively reflects green light in the planar state and the liquid crystal in the bottom layer selectively reflects red light in the planar state.

The above invention is characterized in that the top, middle, and bottom layers are formed one over another in the order listed from a side of the element where a display surface is provided. The above invention is characterized in that it further comprises a light absorbing layer for absorbing light disposed on a side of the bottom layer opposite to a light entering side thereof such that black is displayed when all of the liquid crystals in the top, middle and bottom layers are in a focal conic state.

The above-described object is achieved by an electronic paper displaying an image, comprising the liquid crystal display element according to the above invention.

As a result of a close study, the inventors found that there is a significant relationship between image sticking and the surface roughness of interfaces in contact with a liquid crystal layer. According to the invention, image sticking is suppressed by reducing such surface roughness, and it is therefore possible to provide a liquid crystal display element having high display quality and electronic paper utilizing the element.

### BRIEF DESCRIPTION OF THE DRAWINGS

FIG. 1 is an illustration schematically showing a sectional configuration of a liquid crystal display element according to a first embodiment of the invention;

FIGS. 2A and 2B are illustrations schematically showing one liquid crystal layer of the liquid crystal display element according to the first embodiment of the invention;

FIGS. 3A and 3B are illustrations showing an image display surface of a panel for evaluation of the liquid crystal display element according to the first embodiment of the invention;

FIG. 4 is a graph showing a relationship between degrees of image sticking ΔY and surface roughness Ra of interfaces in contact with a liquid crystal layer observed on the liquid crystal display element according to the first embodiment of the invention;

FIG. 5 is an illustration showing a schematic configuration of a liquid crystal display element according to a second embodiment of the invention;

FIG. 6 is an illustration schematically showing a sectional configuration of the liquid crystal display element according to the second embodiment of the invention;

FIG. 7 is a graph showing examples of reflection spectra of the liquid crystal display element according to the second embodiment of the invention observed in a planar state;

FIGS. 8A and 8B are diagrams showing a method of driving the liquid crystal display element according to the second embodiment of the invention; and

FIG. 9 is a graph showing an example of voltage-reflectance characteristics of a cholesteric liquid crystal.

### DESCRIPTION OF THE PREFERRED EMBODIMENTS

### First Embodiment

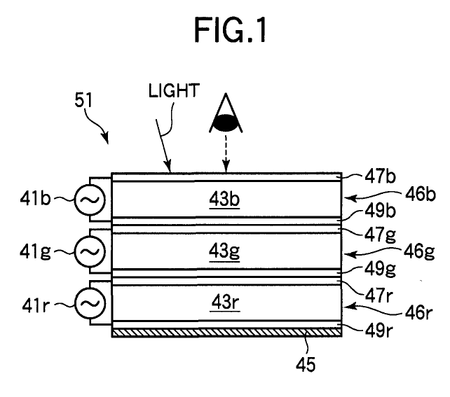

A liquid crystal display element and electronic paper utilizing the element according to a first embodiment of the invention will now be described with reference to FIGS. 1 to 4. FIG. 1 schematically shows a sectional configuration of a liquid crystal display element 51 capable of full-color display utilizing cholesteric liquid crystals. The liquid crystal display element 51 has a structure in which a blue (B) display portion 46b, a green (G) display portion 46g, and a red (R) display portion 46r are formed one over another in the order listed from the side of the element where a display surface is provided. In the illustration, the display surface is located on the side of a top substrate 47b, and external light (indicated by a solid line) impinges on the display surface from above the substrate 47b. An eye of a viewer and the viewing direction (indicated by a broken line) are schematically illustrated above the substrate 47b.

The B display portion 46b includes a blue (B) liquid crystal layer 43b enclosed between a pair of substrates, i.e., a top substrate 47b and a bottom substrate 49b and a pulse voltage source 41b for applying a predetermined pulse voltage to the B liquid crystal layer 43b. The G display portion 46g includes a green (G) liquid crystal layer 43g enclosed between a pair of substrates, i.e., a top substrate 47g and a bottom substrate 49g and a pulse voltage source 41g for applying a predetermined pulse voltage to the G liquid crystal layer 43g. The R display portion 46r includes a red (R) liquid crystal layer 43r enclosed between a pair of substrates, i.e., a top substrate 47r and a bottom substrate 49r and a pulse voltage source 41r for applying a predetermined pulse voltage to the R liquid crystal layer 43r. Although not shown, a plurality of electrodes are formed on an interface side of each top substrate 47 and each bottom substrate 49 which is in contact with the liquid crystal layer 43 to apply a pulse voltage to the liquid crystal layer 43 from the respective pulse voltage source 41. In addition to the electrodes, an alignment film or insulation film may be formed on the interface side of each top substrate 47 and each bottom substrate 49 in contact with the liquid crystal layer 43 as occasion demands. A light absorbing layer 45 is disposed on a bottom surface of the bottom substrate 49r of the R display portion 46r.

The cholesteric liquid crystal used in each of the B, G, and R liquid crystal layers 43b, 43g, and 43r is a liquid crystal mixture obtained by adding a relatively great amount of chiral additive (which is also called a chiral material) to a nematic liquid crystal until a chiral material content of several tens percent by weight is reached. When a nematic liquid crystal includes a relatively great amount of chiral material, it is possible to form a cholesteric phase that is a strong helical twist of nematic liquid crystal molecules. For this reason, a cholesteric liquid crystal is also called a chiral nematic liquid crystal.

A cholesteric liquid crystal has bistability (memory characteristics), and the liquid crystal can be put in any of a planar state, a focal conic state, and an intermediate state that is a mixture of the planar state and the focal conic state by adjusting the intensity of an electric field applied to the same. Once the liquid crystal enters the planar state, the focal conic state, or the mixed or intermediate state, the liquid crystal thereafter remains in the state with stability even if the electric field is removed.

The planar state can be obtained by applying a predetermined high voltage between a top substrate 47 and a bottom substrate 49 to apply an intense electric field to the liquid crystal layer 43 between the substrates and thereafter nullifying the electric field abruptly. The focal conic state can be obtained by applying, for example, a predetermined voltage lower than the above-described high voltage between the top substrate 47 and the bottom substrate 49 to apply an electric field to the liquid crystal layer 43 and thereafter nullifying the electric field abruptly.

The intermediate state that is a mixture of the planer state and the focal conic state can be obtained by applying, for example, a predetermined voltage lower than the voltage to obtain the focal conic state between the top substrate 47 and the bottom substrate 49 to apply an electric field to the liquid crystal layer 43 and thereafter nullifying the electric field abruptly.

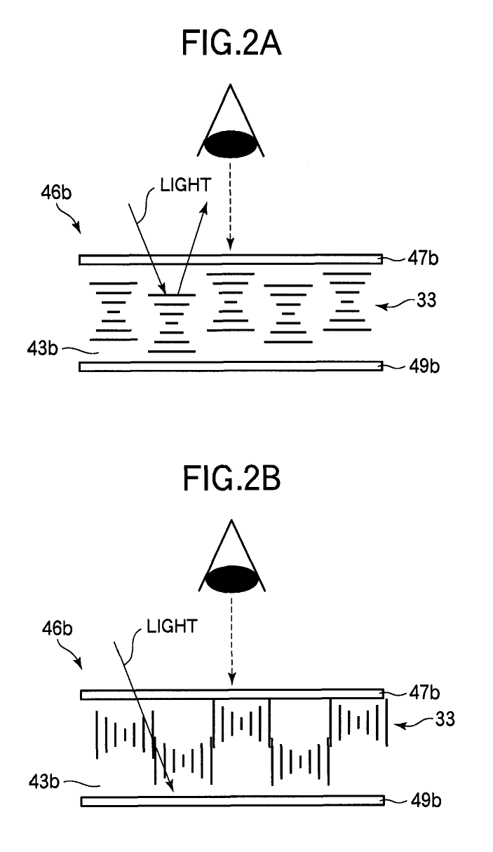

A principle behind a display operation of the liquid crystal display element 51 utilizing cholesteric liquid crystals will now be described taking a B display portion 46b as an example. FIG. 2A shows alignment of liquid crystal molecules 33 of the cholesteric liquid crystal in the B liquid crystal layer 43b of the B display portion 46b observed when the layer is in the planar state. As shown in FIG. 2A, in the planar state, the liquid crystal molecules 33 are sequentially rotated from one another in the direction of the thickness of the substrates to form a helical structure, and the helical axes of the helical structure are substantially perpendicular to the substrate surfaces.

In the planar state, light rays in a predetermined wave band in accordance with the helical pitch of the liquid crystal molecules 33 are selectively reflected by the liquid crystal layer. The reflected light rays are circularly polarized light rays which are either left-handed or right-handed depending on the chirality of the helical pitch. Other types of light rays are transmitted through the liquid crystal layer. Natural light is a mixture of left- and right-handed circularly polarized light rays. Therefore, when natural light in the predetermined wave band enters the liquid crystal layer in the planar state, it is assumed that 50% of the incident light is reflected and the other 50% of the incident light is transmitted by the layer.

A wavelength λ which results in the maximum reflection is given by an equation λ=n·p where n and p represent the average refractive index and the helical pitch of the liquid crystal layer, respectively.

Therefore, in order to allow blue light to be selectively reflected by the B liquid crystal layer 43b of the B display portion 46b in the planar state, for example, the average refractive index n and the helical pitch p are determined such that an equation “λ=480 nm” becomes true. The average refractive index n can be adjusted by selecting the liquid crystal material and the chiral material appropriately, and the helical pitch p can be adjusted by adjusting the chiral material content.

FIG. 2B shows alignment of the liquid crystal molecules 33 observed when the B liquid crystal layer 43b of the B display portion 46b is in the focal conic state. As shown in FIG. 2B, in the focal conic state, the liquid crystal molecules 33 are sequentially rotated from one another in an in-plane direction of the substrate surfaces to form a helical structure, and helical axes of the helical structure are substantially in parallel with the substrate surfaces. In the focal conic state, the B liquid crystal layer 43b loses the selectivity of wavelengths to be reflected, and most of light rays incident on the layer are transmitted. Since the transmitted light rays are absorbed by the light absorbing layer 45 disposed on the bottom surface of the bottom substrate 49r of the R display portion 46r, a dark state (black) can be displayed.

In the intermediate state that is a mixture of the planar and focal conic states, the ratio between reflected light and transmitted light is adjusted according to the ratio between the planar state and the focal conic state to vary the intensity of reflected light. Thus, multi-gray-level display can be achieved according to intensities of reflected light rays.

As thus described, the amount of light reflected by the cholesteric liquid crystal can be controlled using a helically twisted alignment of the liquid crystal molecules 33. The liquid crystal display element 51 capable of full-color display is fabricated by enclosing cholesteric liquid crystals selectively reflecting green light and red light in the planar state in the G liquid crystal layer 43g and the R liquid crystal layer 43r, respectively, in the same manner as done in the above-described B liquid crystal layer 43b. The liquid crystal display element 51 has memory characteristics, and the element can perform full-color display without consuming electric power except when rewriting a screen.

In the present embodiment, measures as described in the following items (1) to (5) are taken to provide the above-described liquid crystal display element 51 with high display quality by suppressing image sticking. While the measures will be described with reference to the green (G) display portion 46g by way of example, the description equally applies to the blue (B) display portion 46b and the red (R) display portion 46r.

(1) The pair of substrates, i.e., the top substrate 47g and the bottom substrate 49g disposed opposite to each other to enclose the green (G) liquid crystal layer 43g therebetween are provided with surface roughness Ra satisfying an expression “0<Ra≦1.5 nm” at their interfaces in contact with the liquid crystal layer 43g.

(2) The surface roughness Ra is preferably set to satisfy an expression “0<Ra≦0.8 nm”.

(3) The electrodes (not shown) formed on the interface sides of the top substrate 47g and the bottom substrate 49g in contact with the liquid crystal layer 43g have surface roughness Ra satisfying the expression shown in the item (1) or (2).

(4) Similarly, the insulation films (not shown) formed on the interface sides of the top substrate 47g and the bottom substrate 49g in contact with the liquid crystal layer 43g has surface roughness Ra satisfying the expression shown in the item (1) or (2).

(5) Similarly, the alignment films (not shown) formed on the interface sides of the top substrate 47g and the bottom substrate 49g in contact with the liquid crystal layer 43g have surface roughness Ra satisfying the expression shown in the item (1) or (2).

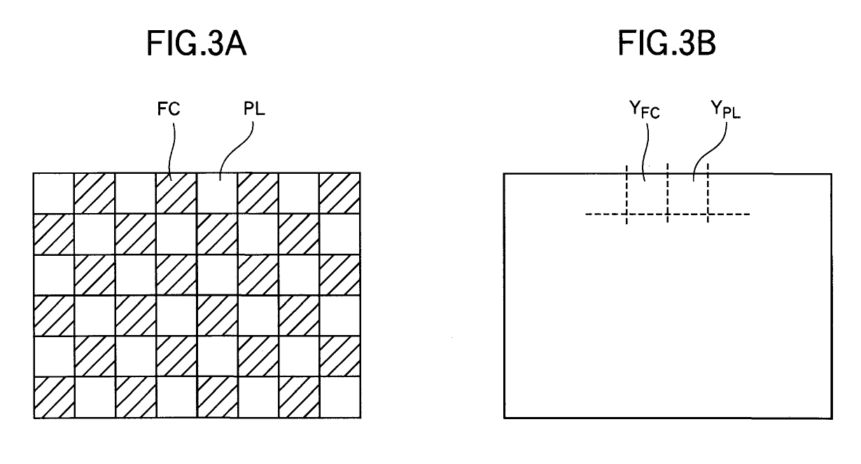

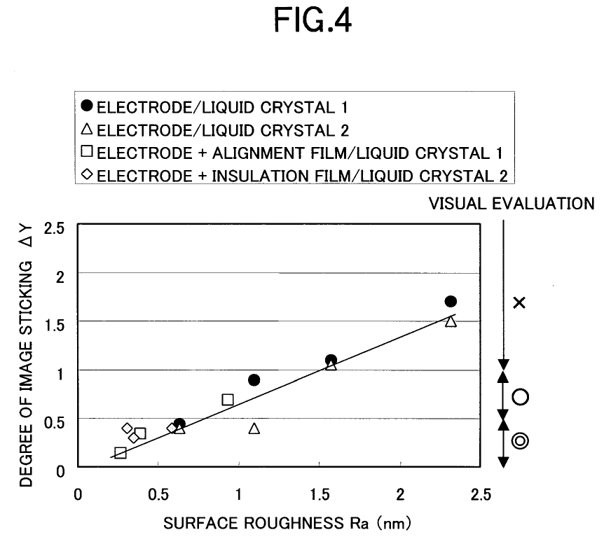

A description will now be made with reference to Table 1, and FIGS. 3 and 4 on reasons why the measures described in the items (1) to (5) are effective in suppressing image sticking. The inventors closely studied the relationship between the surface roughness Ra of the interfaces in contact with the liquid crystal layer and the degree of image sticking. As a result, it was found that image sticking can be suppressed by keeping the surface roughness Ra of the interfaces in contact with the liquid crystal layer greater than 0 and not greater than 1.5 nm or, preferably, keeping the surface roughness not greater than 0.8 nm.

TABLE 1

| | Configurations | Surface Roughness Ra (nm) |
|---|---|---|
| 1 | Electrode A | 0.634 |
| 2 | Electrode B | 1.096 |
| 3 | Electrode C | 1.574 |
| 4 | Electrode D | 2.318 |
| 5 | Electrode A + Alignment Film | 0.264 |
| 6 | Electrode B + Alignment Film | 0.387 |
| 7 | Electrode C + Alignment Film | 0.931 |
| 8 | Electrode A + Insulation Film | 0.305 |
| 9 | Electrode B + Insulation Film | 0.348 |
| 10 | Electrode C + Insulation Film | 0.588 |

Table 1 shows configurations of the interfaces in contact with the liquid crystal layer and values of surface roughness Ra associated with the configurations. The row numbers 1 to 10 of Table 1 represent combinations of ten types of interface configurations and values of surface roughness Ra. As shown on Table 1, the surface roughness Ra of the interfaces in contact with the liquid crystal layer is varied within the range of about 0.26 nm to 2.32 nm. The row numbers 1 to 4 of Table 1 represent configurations in which electrodes for applying a predetermined pulse voltage to the liquid crystal layer are formed on the interface sides of the substrates the 47g and 49g, which are made of glass, in contact with the liquid crystal layer. The surface roughness Ra of the electrodes can be varied by adjusting the material from which the electrodes are formed, the film forming process used for forming the electrodes such as vacuum deposition or sputtering, and electrode fabricating conditions such as substrate temperatures, gas pressures, and annealing conditions. Referring to the substrates represented by the row number 1, their interfaces in contact with the liquid crystal layer are constituted by electrodes A, and the electrodes have surface roughness Ra of 0.634 nm. Referring to the substrates represented by the row number 2, their interfaces in contact with the liquid crystal layer are constituted by electrodes B, and the electrodes have surface roughness Ra of 1.096 nm. Referring to the substrates represented by the row number 3, the interfaces in contact with the liquid crystal layer are constituted by electrodes C, and the electrodes have surface roughness Ra of 1.574 nm. Referring to the substrates represented by the row number 4, their interfaces in contact with the liquid crystal layer are constituted by electrodes D, and the electrodes have surface roughness Ra of 2.318 nm. The surface roughness Ra was measured using an AFM (atomic force microscope).

The row numbers 5 to 7 of Table 1 represent configurations in which alignment films having a thickness of about 100 nm are formed on the electrodes A, B, and C formed on the interface sides of the substrates 47g and 49g represented by the row numbers 1 to 3 in contact with the liquid crystal layer. The surface roughness Ra of the alignment films may be varied by adjusting the thicknesses of the alignment films and the material from which the alignment films are formed. Referring to the substrates represented by the row number 5, their interfaces in contact with the liquid crystal layer are constituted by alignment films covering the electrodes A, and the films have surface roughness Ra of 0.264 nm. Referring to the substrates represented by the row number 6, their interfaces in contact with the liquid crystal layer are constituted by alignment films covering the electrodes B, and the films have surface roughness Ra of 0.387 nm. Referring to the substrates represented by the row number 7, their interfaces in contact with the liquid crystal layer are constituted by alignment films covering the electrodes C, and the films have surface roughness Ra of 0.931 nm.

The row numbers 8 to 10 of Table 1 represent configurations in which insulation films having a thickness of about 100 nm are formed on the electrodes A, B, and C formed on the interface sides of the substrates 47g and 49g represented by the row numbers 1 to 3 in contact with the liquid crystal layer. The surface roughness Ra of the insulation films may be varied by adjusting the thicknesses of the insulation films and the material from which the insulation films are formed. Referring to the substrates represented by the row number 8, their interfaces in contact with the liquid crystal layer are constituted by insulation films covering the electrodes A, and the films have surface roughness Ra of 0.305 nm. Referring to the substrates represented by the row number 9, their interfaces in contact with the liquid crystal layer are constituted by insulation films covering the electrodes B, and the films have surface roughness Ra of 0.348 nm. Referring to the substrates represented by the row number 10, their interfaces in contact with the liquid crystal layer are constituted by insulation films covering the electrodes C, and the films have surface roughness Ra of 0.588 nm.

Ten types of pairs of substrates 47g and 49g having configurations and surface roughness values Ra as shown in the row numbers 1 to 10 on Table 1 were prepared. An epoxy seal material was applied to the periphery of either of each pair of substrates, i.e., substrate 47g or 49g. Spherical spacers made of resin or inorganic oxide were dispersed on the other substrate, i.e., substrate 47g or 49g. The substrates 47g and 49g were combined together to fabricate ten vacant panels with the gap between the substrates 47g and 49g adjusted to provide a cell gap of about 4 μm. A cholesteric liquid crystal (liquid crystal 1) selectively reflecting green light in the planar state was enclosed in each panel to provide a green (G) liquid crystal layer. Therefore, the ten panels have the same configuration as the green (G) display portion 46g. A light absorbing layer 45 was disposed on the bottom of each panel to fabricate ten types of panels for evaluation.

Four types of vacant panels having configurations and surface roughness values Ra as shown in the row numbers 1 to 4 on Table 1 were further prepared. A cholesteric liquid crystal (liquid crystal 2) selectively reflecting green light in the planar state and having a liquid crystal composition different from that of the above-described green (G) liquid crystal layer 43g (liquid crystal 1) was enclosed in each cell to fabricate four types of panels for evaluation.

FIGS. 3A and 3B show an image display surface of a panel for evaluation as described above. FIG. 3A shows a state of the image display surface of the panel for evaluation, in which a checker pattern is displayed in the form of alternating arrays of black squares (areas represented by diagonal hatching) and green squares (areas without hatching). In the areas of the black square patterns, the cholesteric liquid crystal in the panel for evaluation is in the focal conic state. In the areas of the green square patterns, the liquid crystal is in the planar state. The same state of display was maintained for 24 hours. FIG. 3B is a view of the image display surface of the panel for evaluation taken when a predetermined intermediate gray level (represented by the plain background of the drawing) was uniformly displayed after maintaining the state of display shown in FIG. 3A for 24 hours.

In the present embodiment, a degree of image sticking is represented by ΔY. In this case, a degree of image sticking ΔY is defined as a difference between brightness values (|Y_{PL}−Y_{FC}|) taken in the state shown in FIG. 3B in a position PL where the liquid crystal was in the planar state in the state of display shown in FIG. 3A and in a position FC where the liquid crystal was in the focal conic state. That is, ΔY=|Y_{PL}−Y_{FC}|.

FIG. 4 shows a relationship between degrees of image sticking ΔY and surface roughness Ra of interfaces of substrates in contact with a liquid crystal layer. The horizontal axis represents surface roughness Ra (nm), and the vertical axis on the left represents degrees of image sticking ΔY. The vertical axis on the right represents results of visual evaluation of image sticking. The results of visual evaluation are represented by a double circle, a circle, and a cross in the order of preference.

The black circular symbols in FIG. 4 represent data taken on the panels for evaluation which have the interface configurations and surface roughness Ra shown in the row numbers 1 to 4 on Table 1 and in which the liquid crystal 1 is enclosed. The triangular symbols represent data taken on the panels for evaluation which have the interface configurations and surface roughness Ra shown in the row numbers 1 to 4 on Table 1 and in which the liquid crystal 2 is enclosed. The square symbols represent data taken on the panels for evaluation which have the interface configurations and surface roughness Ra shown in the row numbers 5 to 7 on Table 1 and in which the liquid crystal 1 is enclosed. The rhombic symbols represent data taken on the panels for evaluation which have the interface configurations and surface roughness Ra shown in the row numbers 8 to 10 on Table 1 and in which the liquid crystal 1 is enclosed.

The distribution of those items of data in FIG. 4 indicates that the degree of image sticking ΔY substantially linearly decreases as surface roughness is reduced. When examined in association with the visual evaluation of image sticking carried out at the same time, the data indicates that a degree of image sticking ΔY of 1.0 or less represents a negligible level of image sticking and that a degree of image sticking ΔY of 0.5 or less represents a substantially unperceivable level of image sticking.

It would be understood from FIG. 4 that image sticking can be suppressed to a low degree (ΔY) by reducing the surface roughness Ra of a substrate interface of interest in contact with a liquid crystal layer. It would be also understood that image sticking can be kept at a negligible level by keeping the surface roughness Ra of the interface of the substrate in contact with the liquid crystal layer at 1.5 nm or less. It would be also understood that image sticking can be kept at an unperceivable level by keeping the surface roughness Ra of the interface of the substrate in contact with the liquid crystal layer at 0.8 nm or less. This is considered attributable to the fact that a reduction in the surface roughness Ra results in an increase in surface free energy to allow easier transition of the liquid crystal in the neighborhood of the substrate's interface to a stable state.

In the case wherein interfaces with a liquid crystal layer is constituted by electrodes, a higher electric field can be applied to the liquid crystal layer when compared to the case wherein the interfaces are constituted by insulation films or alignment films, and the layer can therefore be driven at a lower voltage. As a result, a screen rewrite can be performed at reduced power consumption. When interfaces with a liquid crystal layer are constituted by insulation films, shorting between the top and bottom substrates attributable to conductive particles or the like can be suppressed. When interfaces with a liquid crystal layer are constituted by an alignment film made of materials represented by polyimide for aligning the liquid crystal, the alignment of the liquid crystal can be controlled. In the case of a cholesteric liquid crystal, such films make it possible to control display characteristics such as reflectance, a viewing angle, and a contrast ratio.

As described above, when interfaces with a liquid crystal layer are constituted by electrodes, insulation films, or alignment films, a high image sticking preventing effect can be achieved by any of the features. It is not essential that interfaces of a pair of substrates in contact with a liquid crystal layer are constituted by the same type of features, and the interfaces may be a combination of two types of features selected from among electrodes, an insulation film, and an alignment film. For example, the following combinations may be used. The interface of one of the substrates may be constituted by electrodes with the interface of the other substrate constituted by an insulation film. The interface of one of the substrates may be constituted by electrodes with the interface of the other substrate constituted by an alignment film. The interface of one of the substrates may be constituted by an insulation film with the interface of the other substrate constituted by an alignment film.

### Second Embodiment

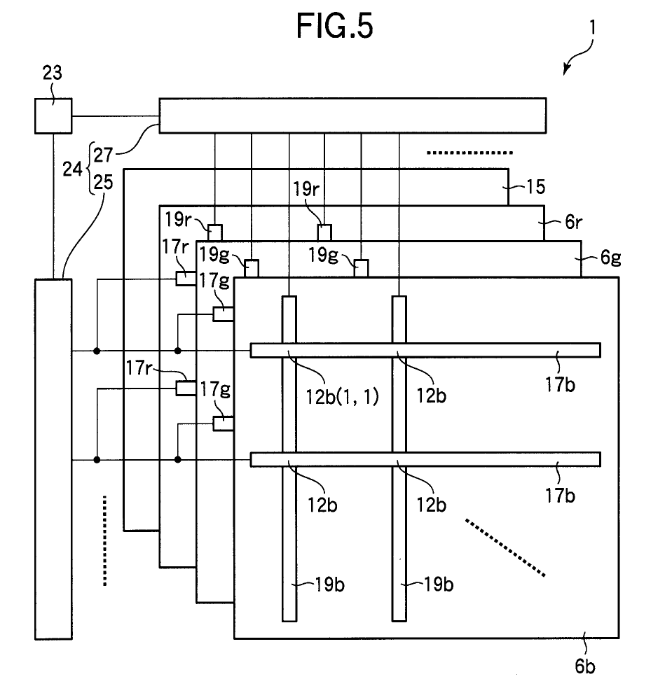

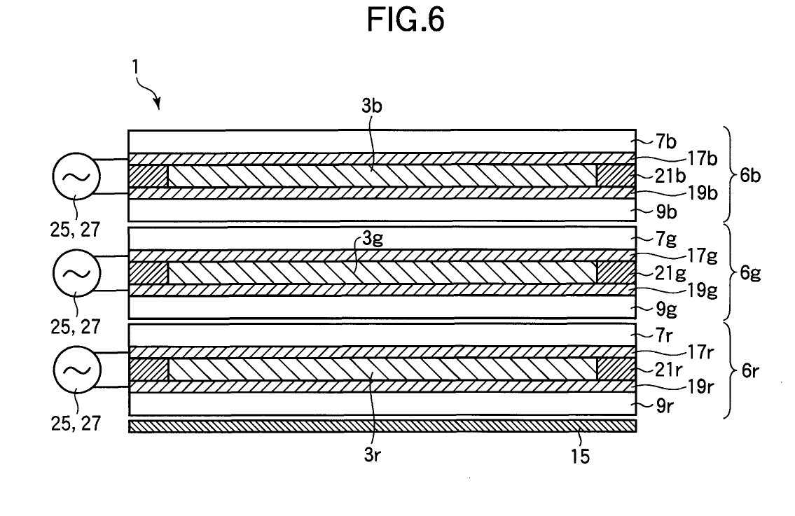

A liquid crystal display element, and electronic paper utilizing the element according to a second embodiment of the invention will now be described with reference to FIGS. 5 to 9. A liquid crystal display element 1 utilizing cholesteric liquid crystals for blue (B), green (G), and red (R) will be described as an example of an embodiment of the invention. FIG. 5 shows a schematic configuration of the liquid crystal display element 1 of the present embodiment. FIG. 6 is a schematic view of a sectional configuration of the liquid crystal display element 1 taken along a straight line extending in parallel with the horizontal direction of FIG. 5.

As shown in FIGS. 5 and 6, the liquid crystal display element 1 includes a B display portion (first display portion) 6b for selectively reflecting blue (B) light as a selected wave band in the planar state, a G display portion (second display portion) 6g for selectively reflecting green (G) light as another selected wave band in the planar state, and an R display portion (third display portion) 6r for selectively reflecting red (R) light as still another selected wave band in the planar state. The B, G, and R display portions 6b, 6g, and 6r are formed one over another in the order listed starting from a side of the element where a light entrance surface (display surface) is provided.

The B display portion 6b includes a pair of substrates, i.e., a top substrate 7b and a bottom substrate 9b disposed to face each other and a B liquid crystal layer 3b enclosed between the substrates 7b and 9b. The B liquid crystal layer 3b is formed by a cholesteric liquid crystal which has right-handed optical rotatory power (right chirality) obtained by adjusting an average refractive index n and a helical pitch p of the layer to reflect blue light selectively. The liquid crystal reflects right-handed circularly polarized rays of blue light and transmits other types of light in the planar state and transmits substantially all types of light in the focal conic state.

The G display portion 6g includes a pair of substrates, i.e., a top substrate 7b and a bottom substrate 9b disposed to face each other and a G liquid crystal layer 3g enclosed between the substrates 7b and 9b. The G liquid crystal layer 3g is formed by a cholesteric liquid crystal which has left-handed optical rotatory power (left chirality) obtained by adjusting an average refractive index n and a helical pitch p of the layer to reflect green light selectively. The liquid crystal reflects left-handed circularly polarized rays of green light and transmits other types of light in the planar state and transmits substantially all types of light in the focal conic state.

The R display portion 6r includes a pair of substrates, i.e., a top substrate 7b and a bottom substrate 9b disposed to face each other and an R liquid crystal layer 3r enclosed between the substrates 7b and 9b. The R liquid crystal layer 3r is formed by a cholesteric liquid crystal which has right-handed optical rotatory power (right chirality) obtained by adjusting an average refractive index n and a helical pitch p of the layer to reflect red light selectively. The liquid crystal reflects right-handed circularly polarized rays of red light and transmits other types of light in the planar state and transmits substantially all types of light in the focal conic state.

The cholesteric liquid crystals constituting the B, G, and R liquid crystal layers 3b, 3g, and 3r are obtained by adding a chiral material to a nematic liquid crystal mixture in an amount to occupy 10 to 40 percent by weight. The chiral material content is a value on an assumption that the total amount of the nematic liquid crystal component and the chiral material corresponds to 100 percent by weight. Various types of known nematic liquid crystals may be used, but it is preferable to use a material having dielectric constant anisotropy Δ∈ satisfying an expression “20≦Δ∈50” in order to keep driving voltages for the liquid crystal layers 3b, 3g, and 3r relatively low. The cholesteric liquid crystals preferably have refractive index anisotropy Δn satisfying an expression “0.18≦Δn≦0.24”. When the refractive index anisotropy Δn is smaller than this range, the liquid crystal layers 3b, 3g, and 3r have undesirably low reflectances in the planar state. When the refractive index anisotropy Δn is greater than this range, the liquid crystal layers 3b, 3g, and 3r have significant scattering reflections in the focal conic state. In addition, the layers will have high viscosity which will result in a reduced response speed.

The chiral materials added to the B and R cholesteric liquid crystals are optical isomers having optical rotatory power different from that of the chiral material added to the G cholesteric liquid crystal. Thus, the B and R cholesteric liquid crystals are the same as each other and different from the G cholesteric liquid crystal in terms of optical rotatory power.

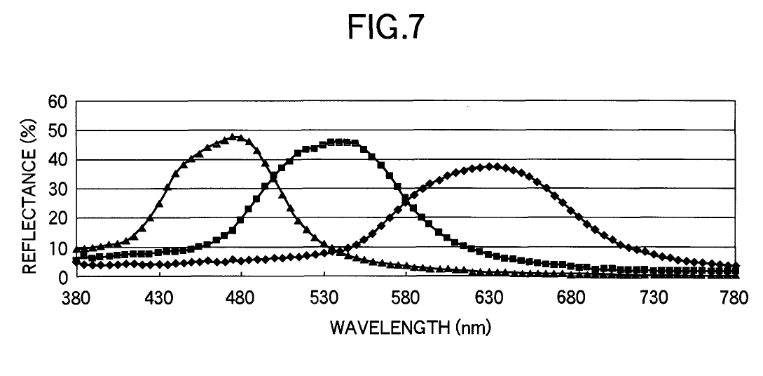

FIG. 7 shows examples of reflection spectra of the liquid crystal layers 3b, 3g, and 3r in the planar state. The horizontal axis represents wavelength (nm) of reflected light, and the vertical axis represents reflectance (in percentages in comparison to that of a white plate). The curve connecting the black triangular symbols in the figure represents a reflection spectrum observed at the B liquid crystal layer 3b. The curve connecting the black square symbols in the figure represents a reflection spectrum observed at the G liquid crystal layer 3g. The curve connecting the black rhombic symbols in the figure represents a reflection spectrum observed at the R liquid crystal layer 3r.

As shown in FIG. 7, center wavelengths of the reflection spectra of the liquid crystal layers 3b, 3g, and 3r in the planar state have magnitudes ascending in the order in which the layers are listed. In the multi-layer structure formed by the B, G, and R display portions 6b, 6g, and 6r, the optical rotatory power of the G liquid crystal layer 3g is different from the optical rotatory power of the B liquid crystal layer 3b and the R liquid crystal layer 3r in the planar state. Therefore, in the region where the blue and green reflection spectra overlap and the region where the green and red reflection spectra overlap as shown in FIG. 7, for example, right-handed circularly polarized rays of light can be reflected by the B liquid crystal layer 3b and the R liquid crystal layer 3r, and left-handed circularly polarized rays of light can be reflected by the G liquid crystal layer 3g. Thus, loss of reflected light can be reduced, and the liquid crystal display element 1 can be provided with a display surface having improved brightness.

The top substrates 7b, 7g, and 7r and the bottom substrates 9b, 9g, and 9r must be translucent. In the present embodiment, two polycarbonate (PC) film substrates cut to have longitudinal and transversal lengths of 10 (cm)×8 (cm) are used. Instead of PC substrates, glass substrates or film substrates made of polyethyleneterephthalate (PET) or the like may be used. Film substrates made from such materials have sufficient flexibility. Although the top substrates 7b, 7g, and 7r and the bottom substrates 9b, 9g, and 9r are all translucent in the present embodiment, the bottom substrate 9r of the R display portion 6r disposed to constitute the lowermost layer may be opaque.

As shown in FIGS. 5 and 6, a plurality of data electrodes 19b in the form of strips are formed in parallel on the side of the bottom substrate 9b of the B display portion 6b facing the B liquid crystal layer 3b, the electrodes extending in the vertical direction of FIG. 5. The symbol 19b in FIG. 6 expresses a region where a plurality of data electrode 19b are present. A plurality of scan electrodes 17b in the form of strips are formed in parallel on the side of the top substrate 7b facing the B liquid crystal layer 3b, the electrodes extending in the horizontal direction of FIG. 5. The data electrodes 19b and the scan electrodes 17b are formed to have surface roughness Ra of 1.5 nm or less or, more preferably, 0.8 nm or less at their interfaces in contact with the liquid crystal layer. In the present embodiment, the data electrodes 19b and the scan electrodes 17b have surface roughness of about 0.63 nm. Thus, the image sticking phenomenon which can degrade display quality can be significantly suppressed.

As shown in FIG. 5, the plurality of scan electrodes 17b and data electrodes 19b are disposed in a face-to-face relationship such that they intersect each other when viewed in the normal direction of the surfaces of the top substrate 7b and the bottom substrate 9b where the electrodes are formed. In the present embodiment, transparent electrodes are patterned to form 240 scan electrodes 17b and 320 data electrodes 19b in the form of stripes having a pitch of 0.24 mm to allow QVGA display of 240×320 dots. Each of intersections between the electrodes 17b and 19b constitutes a B pixel 12b. A plurality of B pixels 12b are disposed in the form of a matrix having 240 rows and 320 columns.

Like the B display portion 6b, the G display portion 6g is formed with 240 scan electrodes 17g, 320 data electrodes 19g, and G pixels 12g (not shown) arranged in the form of a matrix having 240 rows and 320 columns. Similarly, the R display portion 6r is formed with scan electrodes 17r, data electrodes 19r, and R pixels 12r (not shown). The data electrodes 19g and 19r and the scan electrodes 17g and 17r are formed to have surface roughness of 1.5 nm or less or, more preferably, 0.8 nm or less at their interfaces in contact with the respective liquid crystal layers. In the present embodiment, the data electrodes 19g and 19r and the scan electrodes 17g and 19r have surface roughness of about 0.63 nm. One set of B, G, and R pixels 12b, 12g, and 12r constitutes one pixel 12 of the liquid crystal display element 1. Pixels 12 are arranged like a matrix to form a display screen.

For example, a typical material used to form the scan electrodes 17b, 17g, and 17r and the data electrodes 19b, 19g, and 19r is an indium tin oxide (ITO). Alternatively, transparent conductive films made of an indium zinc oxide (IZO) or the like, metal electrodes made of aluminum or silicon, and transparent conductive films made of amorphous silicon or the like may be used.

A scan electrode driving circuit 25 carrying scan electrode driver ICs for driving the plurality of scan electrodes 17b, 17g, and 17r is connected to the top substrates 7b, 7g, and 7r. A data electrode driving circuit 27 carrying data electrode driver ICs for driving the plurality of data electrodes 19b, 19g, and 19r is connected to the bottom substrates 9b, 9g, and 9r. A driving section 24 is formed by including the scan electrode driving circuit 25 and the data electrode driving circuit 27.

Based on a predetermined signal output from a control circuit section 23, the scan electrode driving circuit 25 selects predetermined three scan electrodes 17b, 17g, and 17r and simultaneously outputs a scan signal to the three scan electrodes 17b, 17g, and 17r. Based on a predetermined signal output from the control circuit section 23, the data electrode driving circuit 27 outputs image data signals for the B, G, and R pixels 12b, 12g, and 12r on the selected scan electrodes 17b, 17g, and 17r to the respective data electrodes 19b, 19g, and 19r. For example, general-purpose STN driver ICs having a TCP (tape carrier package) structure are used as the scan electrode driver ICs and the data electrode driver ICs.

In the present embodiment, since driving voltages for the B, G, and R liquid crystal layers 3b, 3g, and 3r can be made substantially equal to each other, a predetermined output terminal of the scan electrode driving circuit 25 is commonly connected to predetermined input terminals of scan electrodes 17b, 17g, and 17r. Thus, there is no need for providing a scan electrode driving circuit 25 for each of the B, G, and R display portions 6b, 6g, and 6r, and the configuration of the driving circuit of the liquid crystal display element 1 can therefore be made simple. Since the number of scan electrode driver ICs required is small, the liquid crystal display element 1 can be manufactured at a low cost. The sharing of the output terminal of the scan electrode driving circuit 25 between B, G, and R display portions may be implemented as occasion demands.

Each of the electrodes 17b and 19b may be coated with a functional film, e.g., an insulation film or alignment film for controlling the alignment of liquid crystal molecules (neither of the films is shown). The insulation film has the function of preventing shorting between the electrodes 17b and 19b, and the film also serves as a gas barrier layer having the function of improving the reliability of the liquid crystal display element 1. The alignment film may be an organic film such as a polyimide resin, a polyamide-imide resin, a polyether imide resin, a polyvinyl butyral resin, or an acryl resin, and an inorganic material such as a silicon oxide or an aluminum oxide may alternatively be used. The alignment film may be also used as an insulating thin film.

For example, when insulation films or alignment films are applied throughout the substrates to coat the electrodes 17b and 19b, the interfaces of the films in contact with the liquid crystal layer are formed to have surface roughness of 1.5 nm or less or, more preferably, 0.8 nm or less. Thus, the image sticking phenomenon which affects display quality can be significantly suppressed.

As shown in FIG. 6, the B liquid crystal layer 3b is enclosed between the substrates 7b and 9b by a seal material 21b applied to the peripheries of the top and bottom substrates 7b and 9b. The thickness (cell gap d) of the B liquid crystal layer 3b must be kept uniform. In order to maintain a predetermined cell gap d, spherical spacers made of a resin or inorganic oxide are dispersed in the B liquid crystal layer 3b. Alternatively, a plurality of columnar spacers coated with a thermoplastic resin on the surface thereof are formed in the B liquid crystal layer 3b. In the liquid crystal display element 1 of the present embodiment, spacers (not shown) are inserted in the B liquid crystal layer 3b to keep the cell gap d uniform. More preferably, a wall structure having adhesive properties may be formed to surround pixels. Preferably, the B liquid crystal layer 3b has a cell gap d in the range of 3 μm≦d≦6 μm. The liquid crystal layer 3b has an undesirably low reflectance when the cell gap d is smaller than the range and requires an excessively high driving voltage when the cell gap is greater than the range.

The structure of the G display portion 6g and the R display portion 6r will not be described because it is similar to that of the B display portion 6b. A visible light absorbing layer 15 is provided on the outer surface (bottom surface) of the bottom substrate 9r of the R display portion 6r. Since the visible light absorbing layer 15 is provided, rays of light which have not been reflected by the B, G, and R liquid crystal layers 3b, 3g, and 3r can be efficiently absorbed. Therefore, the liquid crystal display element 1 can display an image with a high contrast ratio. The visible light absorbing layer 15 may be provided as occasion demands.

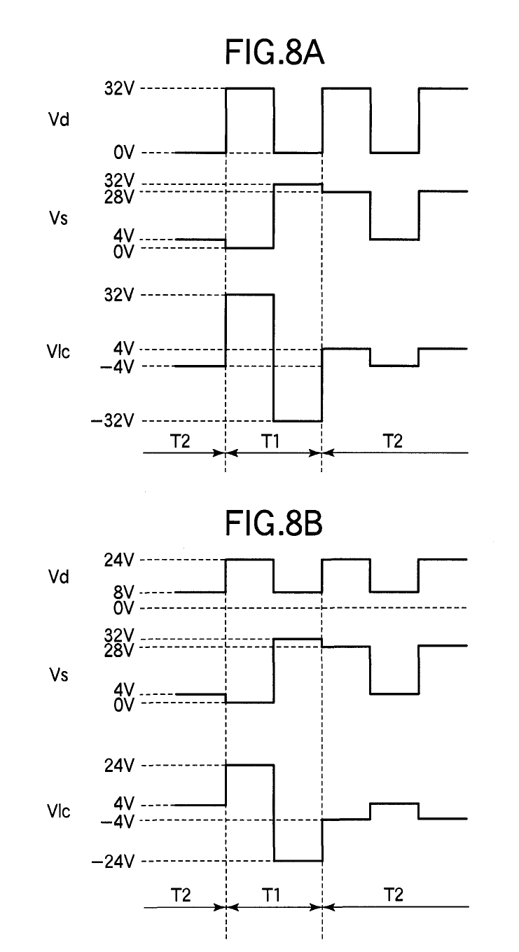

A method of driving the liquid crystal display element 1 will now be described with reference to FIGS. 8A and 8B. FIG. 8A shows driving waveforms for putting a cholesteric liquid crystal in the planar state, and FIG. 8B shows driving waveforms for putting a cholesteric liquid crystal in the focal conic state. In each of FIGS. 8A and 8B, a data signal voltage waveform Vd output from the data electrode driving circuit 27 is shown in the top part; a scan signal voltage waveform Vs output from the scan electrode driving circuit 25 is shown in the middle part; and an applied voltage waveform Vlc applied to the 12b of the B liquid crystal layer 3b is shown in the bottom part. In FIGS. 8A and 8B, time is shown to lapse in the left-to-right direction in the figures, and voltages are represented in the vertical direction of the figures.

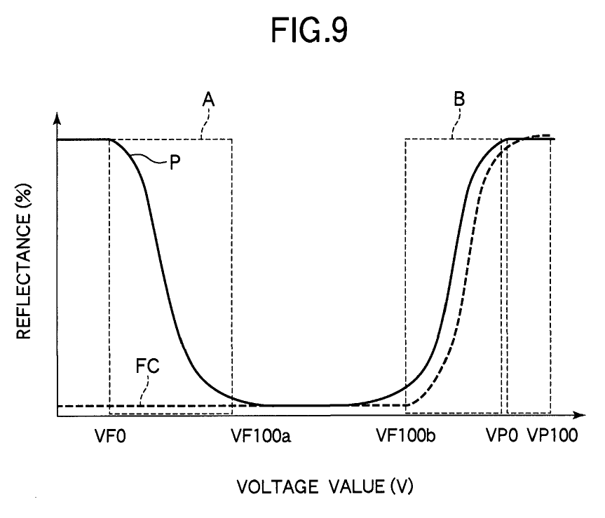

FIG. 9 shows an example of voltage-reflectance characteristics of a cholesteric liquid crystal. The horizontal axis represents voltage value (V) applied to the cholesteric liquid crystal, and the vertical axis represents reflectance (%) of the cholesteric liquid crystal. The curve Pin a solid line shown in FIG. 9 represents voltage-reflectance characteristics observed when the cholesteric liquid crystal is initially in the planar state, and the curve FC in a broken line represents voltage-reflectance characteristics observed when the cholesteric liquid crystal is initially in the focal conic state.

An example will now be described, in which a predetermined voltage is applied to a blue (B) pixel 12b (1,1) that is located at the intersection between the data electrode 19b of the first column of the B display portion 6b shown in FIG. 5 and the scanning electrode 17b of the first row. As shown in FIG. 8A, in the first half of a selection period T1 during which the scan electrode 17b in the first row is selected, the data signal voltage Vd is +32 V, whereas the scan signal voltage Vs is 0 V. In about the second half of the period, the data signal voltage Vd is 0 V, whereas the scan signal voltage Vs is +32 V. Therefore, a pulse voltage of +32 V is applied to the B liquid crystal layer 3b at the B pixel 12b (1,1) during the selection period T1. When a predetermined high voltage VP100 (e.g., 32 V) is applied to the cholesteric liquid crystal as shown in FIG. 9 to generate a strong electric field therein, the helical structure of liquid crystal molecules is completely decomposed into a homeotropic state in which all liquid crystal molecules follow the direction of the electric field. Therefore, the liquid crystal molecules in the B liquid crystal layer 3b at the B pixel 12b (1,1) are in the homeotropic state during the selection period T1.

When the selection period T1 ends and a non-selection period T2 starts, voltages of, for sample, +28 V and +4 V having a period equivalent to one half of the selection period T1 are applied to the scan electrode 17b of the first row. On the other hand, predetermined data signal voltages Vd are applied to the data electrode 19b of the first column. In FIG. 8A, voltages of, for sample, +32 V and 0 V having a period equivalent to one half of the selection period T1 are applied to the data electrode 19b of the first column in the non-election period T2 following the selection period T1. Therefore, a pulse voltage VF0 of +4 V is applied to the B liquid crystal layer 3b at the B pixel 12b (1,1) during the non-selection period T2. As a result, the electric field generated in the B liquid crystal layer 3b at the B pixel 12b (1,1) during the non-selection period T2 is made substantially zero.

When the voltage applied to the liquid crystal changes from the voltage VP100 (±32 V) to the voltage VF0 (±4 V) to make the electric field substantially zero abruptly with the liquid crystal molecules in the homeotropic state, the liquid crystal molecules enter a helical state in which the helical axes are directed substantially perpendicular to the electrodes 17b and 19b. Thus, the liquid crystal enters the planar state, in which rays of light in accordance with the helical pitch are selectively reflected. Since the B liquid crystal layer 3b at the B pixel 12b (1,1) thus enters the planar state to reflect light, blue is displayed at the B pixel 12b(1,1).

As shown in FIG. 8B, in about the first half of the selection period T1 and in about the second half of the period, the data signal voltage Vd is 24 V and 8 V, respectively, whereas the scan signal voltage Vs is 0 V and +32 V, respectively. Then, a pulse voltage of ±24 V is applied to the B liquid crystal layer 3b at the B pixel 12b (1,1). When a predetermined low voltage VF100b (e.g., 24 V) is applied to the cholesteric liquid crystal as shown in FIG. 9 to generate a weak electric field therein, the helical structure of the liquid crystal molecules is not completely decomposed. In the non-selection period T2, for example, voltages of +28 V and +4 V having a period equivalent to one half of the selection period T are applied to the scan electrode 17b of the first row, and predetermined data signal voltages Vd (e.g., +24 V and 8 V) having a period equivalent to one half of the selection period T1 are applied to the data electrode 19b. Thus, a pulse voltage VF0 of ±4 V is applied to the B liquid crystal layer 3b at the B pixel 12b (1,1) during the non-selection period T2. As a result, the electric field generated in the B liquid crystal layer 3b at the B pixel 12b (1,1) is made substantially zero during the non-selection period T2.

When the voltage applied to the cholesteric liquid crystal changes from the voltage VF100b (±24 V) to the voltage VF0 (±4 V) to make the electric field substantially zero abruptly in the state in which the helical structure of the liquid crystal molecules is not completely decomposed, the liquid crystal molecules enter a helical state in which helical axes are directed substantially parallel to the electrodes 17b and 19b. That is, the liquid crystal molecules enter the focal conic state in which incident light is transmitted. Thus, the B liquid crystal layer 3b at the B pixel 12b(1,1) enters the focal conic state to transmit light. As shown in FIG. 9, the cholesteric liquid crystal can be also put in the focal conic state by applying the voltage VP100 to generate a strong electric field in the liquid crystal layer and by thereafter removing the electric field slowly.

The driving voltages and driving method described above are merely examples. When a pulse voltage of 30 to 35 V is applied between the electrodes for an effective duration of 20 ms at room temperature, the cholesteric liquid crystal of the B liquid crystal layer enters a state for selective reflection (planar state). When a pulse voltage of 15 to 22 V is applied for an effective duration of 20 ms, the cholesteric liquid crystal enters a highly transmissive state (focal conic state).

A green (G) pixel (1,1) and a red (R) pixel (1,1) are driven in the same manner in which the B pixel (1,1) is driven, whereby color display can be performed at a pixel (1,1) that is formed by the three pixels, i.e., the B, G, and R pixels (1,1), (1,1), and (1,1) stacked one over another. The scan electrodes constituting the first to n-th rows may be driven in the so-called line sequential mode to rewrite the data voltage at each data electrode of each row (data scan), whereby display data can be output to all of pixels (1,1) to (n, m) to achieve color display of one frame (display screen).

When voltage in the two frames A and B shown in FIG. 9 is applied to provide electric field of intermediate strength to the cholesteric liquid crystal and then the electric field is removed abruptly, the cholesteric liquid crystal is put in an intermediate state in which a planer state and a focal conic state are mixed, whereby full color display is achieved.

A method of manufacturing the liquid crystal display element 1 according to this embodiment will now be specifically described.

### Example 1

ITO transparent electrodes are formed using a sputtering process on two PC film substrates which have been cut into lengths of 10 cm and 8 cm in longitudinal and transversal directions, respectively, such that the electrodes have surface roughness Ra of about 0.63 nm. The ITO electrodes are then patterned at a photolithographic step to form electrodes in the form of stripes having a pitch of 0.24 mm (scan electrodes 17 and data electrodes 19) the respective substrates. Thus, stripe-like electrodes are formed on the two PC film substrates, respectively, to allow QVGA display of 320×240 dots.

Then, an epoxy type seal material 21 is applied to a peripheral part of either of the PC film substrates using a dispenser. Next, spacers having an average diameter of 4 μm (manufactured by SEKISUI FINE CHEMICAL) are dispersed on the other PC film substrate, i.e., the substrate 9 or 7. Then, the two PC film substrates 7 and 9 are combined and heated for one hour at 160° C. to cure the seal material 21. Then, after injecting a B cholesteric liquid crystal LCb using a vacuum injection process, the injection port is sealed with an epoxy type sealing material to fabricate a B display portion 6b. G and R display portions 6g and 6r are fabricated using the same method.

Next, the B, G, and R display portions 6b, 6g, and 6r are stacked in the order listed from the side of a display surface. Then, a visible light absorbing layer 15 is disposed on a bottom surface of a bottom substrate 9r of the R display portion 6r. General purpose STN driver ICs in a TCP structure are then crimped to terminal parts of scanning electrodes 17 and data electrodes 19 of the B, G, and R display portions 6b, 6g, and 6r stacked one over another, and a power supply circuit and a control circuit section 23 are further connected. Thus, a liquid crystal display element 1 capable of QVGA display is completed. Although not shown, electronic paper is completed by providing the liquid crystal display element 1 thus completed with an input/output device and a control device for exercising overall control of the element (neither of which is shown).

In the liquid crystal display element 1 and the electronic paper of this example, since the transparent electrodes 17 and 19 constituted by stripe-like ITOs formed on the two respective PC film substrates 7 and 9 have surface roughness Ra of about 0.63 nm, image sticking can be significantly suppressed.

Modifications of the structure and manufacturing method of the liquid crystal display element 1 of the present embodiment will now be specifically described.

### Example 2

ITO transparent electrodes are formed using a sputtering process on two PC film substrates 7 and 9 which have been cut into lengths of 10 cm and 8 cm in longitudinal and transversal directions, respectively, such that the electrodes have surface roughness Ra of about 0.63 nm. The ITO electrodes are then patterned at a photolithographic step to form electrodes in the form of stripes having a pitch of 0.24 mm (scan electrodes 17 and data electrodes 19) the respective substrates. Thus, stripe-like electrodes are formed on the two PC film substrates, respectively, to allow QVGA display of 320×240 dots.

Then, a polyimide type alignment film material is applied to the stripe-like transparent electrodes 17 and 19 on the two respective PC film substrates 7 and 9 to a thickness of about 70 nm using a spin coat process such that surface roughness Ra of about 0.26 nm is achieved after the alignment films are formed. Next, the two PC film substrates 7 and 9 coated with the alignment film material are baked for one hour in an oven at 90° C. to preliminarily bake the alignment films. The alignment film may be formed only on either of the substrates.

Next, an epoxy type seal material 21 is applied to a peripheral part of either of the PC film substrates 7 and 9 using a dispenser. Next, spacers having an average diameter of 4 μm are dispersed on the other PC film substrate, i.e., the substrate 9 or 7. Then, the two PC film substrates 7 and 9 are combined and heated for one hour at 160° C. to cure the seal material 21 and to perform final baking of the alignment films. Then, after injecting a B cholesteric liquid crystal LCb using a vacuum injection process, the injection port is sealed with an epoxy type sealing material to fabricate a B display portion 6b. G and R display portions 6g and 6r are fabricated using the same method.

Next, the B, G, and R display portions 6b, 6g, and 6r are stacked in the order listed from the side of a display surface, as shown in FIG. 6. Then, a visible light absorbing layer 15 is disposed on a bottom surface of a bottom substrate 9r of the R display portion 6r. General purpose STN driver ICs in a TCP structure are then crimped to terminal parts of scanning electrodes 17 and data electrodes 19 of the B, G, and R display portions 6b, 6g, and 6r stacked one over another, and a power supply circuit and a control circuit section 23 are further connected. Thus, a liquid crystal display element 1 capable of QVGA display is completed. Although not shown, electronic paper is completed by providing the liquid crystal display element 1 thus completed with an input/output device and a control device for exercising overall control of the element (neither of which is shown).

In the liquid crystal display element 1 and the electronic paper of this example, since the alignment films formed on the stripe-like transparent electrodes 17 and 19 on the two respective PC film substrates 7 and 9 have surface roughness Ra of about 0.26 nm, image sticking can be significantly suppressed.

### Example 3

In the same manner as in Example 1, ITO transparent electrodes are formed using a sputtering process on two PC film substrates 7 and 9 which have been cut into lengths of 10 cm and 8 cm in longitudinal and transversal directions, respectively, such that the electrodes have surface roughness Ra of about 0.63 nm. The ITO electrodes are then patterned at a photolithographic step to form electrodes in the form of stripes having a pitch of 0.24 mm (scan electrodes 17 and data electrodes 19) the respective substrates. Thus, stripe-like electrodes are formed on the two PC film substrates, respectively, to allow QVGA display of 320×240 dots.

Then, SiO₂ films are applied to the stripe-like transparent electrodes 17 and 19 on the two respective PC film substrates 7 and 9 to a thickness of about 100 nm using a spin coat process such that surface roughness Ra of about 0.31 nm is achieved after the insulation films are formed. Next, the two PC film substrates 7 and 9 coated with the insulation films are baked for one hour in an oven at 120C. The insulation film may be formed only on either of the substrates.

Next, an epoxy type seal material 21 is applied to a peripheral part of either of the PC film substrates 7 and 9 using a dispenser. Next, spacers having an average diameter of 4 μm are dispersed on the other PC film substrate, i.e., the substrate 9 or 7. Then, the two PC film substrates 7 and 9 are combined and heated for one hour at 160° C. to cure the seal material 21. Then, after injecting a B cholesteric liquid crystal LCb using a vacuum injection process, the injection port is sealed with an epoxy type sealing material to fabricate a B display portion 6b. G and R display portions 6g and 6r are fabricated using the same method.

Next, the B, G, and R display portions 6b, 6g, and 6r are stacked in the order listed from the side of a display surface in the same manner as in the above-described embodiments, as shown in FIG. 6. Then, a visible light absorbing layer 15 is disposed on a bottom surface of a bottom substrate 9r of the R display portion 6r. General purpose STN driver ICs in a TCP structure are then crimped to terminal parts of scanning electrodes 17 and data electrodes 19 of the B, G, and R display portions 6b, 6g, and 6r stacked one over another, and a power supply circuit and a control circuit section 23 are further connected. Thus, a liquid crystal display element 1 capable of QVGA display is completed. Although not shown, electronic paper is completed by providing the liquid crystal display element 1 thus completed with an input/output device and a control device for exercising overall control of the element (neither of which is shown).

In the liquid crystal display element 1 and the electronic paper of this example, since the insulation films formed on the stripe-like transparent electrodes 17 and 19 on the two respective PC film substrates 7 and 9 have surface roughness Ra of about 0.31 nm, image sticking can be significantly suppressed.

Although the above-described embodiments have three display portions for R, G, and B, it is obvious that the advantages of the invention can be demonstrated independently of the number of display portions.

As described above in detail, according to the embodiments of the invention, image sticking occurring at a display element utilizing cholesteric liquid crystals can be suppressed to improve display quality. It is also possible to provide electronic paper utilizing such a display element.

The invention is not limited to the above-described embodiments and may be modified in various ways.

Although the above embodiments have been described as using the line-sequential driving (line-sequential scanning) method as an example, the driving method may be point-sequential driving.

The above embodiments have been described as liquid crystal display elements having a three-layer structure formed by stacking B, G, and R display portions 6b, 6g, and 6r one over another as an example. However, the invention is not limited to such elements and may be applied to liquid crystal display elements having a structure with one or two layers or four or more layers.

The above embodiments have been described as liquid crystal display elements including display portions 6b, 6g, and 6r having liquid crystal layers 3b, 3g, and 3r for reflecting blue, green, and red rays of light in the planar state, as an example. However, the invention is not limited to such elements and may be applied to liquid crystal display elements including three display portions having liquid crystal layers for reflecting cyan, magenta, and yellow rays of light in the planar state.

What is claimed is:

1. A liquid crystal display element comprising:
a pair of substrates disposed opposite to each other; and
a liquid crystal layer enclosed between the pair of substrates,
wherein an interface of the pair of substrates in contact with the liquid crystal layer has surface roughness of 1.5 nm or less.

2. The liquid crystal display element according to claim 1, wherein the surface roughness is 0.8 nm or less.

3. The liquid crystal display element according to claim 1, wherein at least either of the pair of substrates includes an electrode formed on the side of the interface, and the surface roughness is the roughness of a surface of the electrode.

4. The liquid crystal display element according to claim 1, wherein at least either of the pair of substrates includes an insulation film formed on the side of the interface and wherein the surface roughness is the roughness of a surface of the insulation film.

5. The liquid crystal display element according to claim 1, wherein at least either of the pair of substrates includes an alignment film formed on the side of the interface and wherein the surface roughness is the roughness of a surface of the alignment film.

6. The liquid crystal display element according to claim 1, wherein the liquid crystal layer includes a liquid crystal which forms a cholesteric phase.

7. The liquid crystal display element according to claim 6, wherein a plurality of the pairs of substrates having the liquid crystal layer enclosed therein are stacked one over another.

8. The liquid crystal display element according to claim 7, wherein the pairs of substrates having the liquid crystal layer enclosed therein are stacked as top, middle, and bottom layers and wherein the liquid crystal in the middle layer has optical rotatory power different from that of the top and bottom layers.

9. The liquid crystal display element according to claim 8, wherein the liquid crystal in the top layer selectively reflects blue light in a planar state, the liquid crystal in the middle layer selectively reflects green light in the planar state and the liquid crystal in the bottom layer selectively reflects red light in the planar state.

10. The liquid crystal display element according to claim 9, wherein the top, middle, and bottom layers are formed one over another in the order listed from a side of the element where a display surface is provided.

11. The liquid crystal display element according to claim 1, comprising a light absorbing layer for absorbing light disposed on a side of the bottom layer opposite to a light entering side thereof such that black is displayed when all of the liquid crystals in the top, middle and bottom layers are in a focal conic state.

12. An electronic paper displaying an image, comprising the liquid crystal display element according to claim 1.
